(19) United States
(12) Patent Application Publication
(10) Pub. No.: US 2022/0417042 A1
(43) Pub. Date: Dec. 29, 2022

(54) PLATFORM SEALING SECRETS USING PHYSICALLY UNCLONABLE FUNCTION (PUF) WITH TRUSTED COMPUTING BASE (TCB) RECOVERABILITY

(71) Applicant: Intel Corporation, Santa Clara, CA (US)

(72) Inventors: Siddhartha Chhabra, Portland, OR (US); Prashant Dewan, Portland, OR (US)

(73) Assignee: Intel Corporation, Santa Clara, CA (US)

(21) Appl. No.: 17/358,238

(22) Filed: Jun. 25, 2021

(51) Int. Cl. H04L 9/32; H04L 9/08

(52) U.S. Cl. CPC H04L 9/3278; H04L 9/0897; H04L 9/0869

(57) ABSTRACT

Methods and apparatus relating to provision of platform sealing secrets using a Physically Unclonable Function (PUF) with Trusted Computing Based (TCB) Recoverability are described. In an embodiment, decode circuitry decodes an instruction to determine data to be cryptographically protected and a challenge for a Physically Unclonable Function (PUF) circuitry. Execution circuitry executes the decoded instruction to cryptographically protect the data in accordance with a key, wherein the PUF circuitry is to generate the key in response to the challenge. Other embodiments are also disclosed and claimed.

### FIELD

The present disclosure generally relates to the field of electronics. More particularly, an embodiment relates to provision of platform sealing secrets using a Physically Unclonable Function (PUF) with Trusted Computing Based (TCB) Recoverability.

### BACKGROUND

A Physically Unclonable Function (PUF) generally refers to a physical object that, for a given input and conditions (challenge), provides a physically-defined output (response) that can serve as a unique identifier for a semiconductor device. An example PUF is an array of transistor devices, the response of which is based on unique physical variations that occur naturally during semiconductor manufacturing. Because of this unique response, PUFs may be used to provide platform-unique entropy, which can in turn be used to generate unclonable cryptographic keys. Since the PUF-generated entropy is unique to a platform, the same PUF circuit used on a different platform will generate a different entropy, which in turn makes the cryptographic keys generated by the PUF unclonable.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of a Physically Unclonable Function (PUF) component which may be utilized in an embodiment.

FIG. 2 illustrates a block diagram of various components used to wrap and/or unwrap secrets, according to one or more embodiments.

FIG. 3 illustrates a flow diagram of a method for software sealing/unsealing of secrets, according to an embodiment.

FIG. 4 illustrates a flow diagram of a method for cryptographic key programming, according to an embodiment.

FIG. 5 illustrates the security value in terms of exposure of the keys, according to an embodiment.

FIGS. 6, 7, and 8 illustrate sample structure details according to some embodiments.

FIG. 9 shows the platform configuration to which a wrapped blobs can be bound, according to an embodiment.

FIG. 10 illustrates a sample 64-bit identifier for programming, according to an embodiment.

FIGS. 11, 12, and 13 illustrate pseudocodes for various instructions, according to some embodiments.

FIG. 14A is a block diagram illustrating an exemplary instruction format according to embodiments.

FIG. 14B is a block diagram illustrating the fields of the instruction format that make up the full opcode field according to one embodiment.

FIG. 14C is a block diagram illustrating the fields of the instruction format that make up the register index field according to one embodiment.

FIG. 14D is a block diagram illustrating the fields of the instruction format that make up the augmentation operation field according to one embodiment.

FIG. 15 is a block diagram of a register architecture according to one embodiment.

FIG. 16A is a block diagram illustrating both an exemplary in-order pipeline and an exemplary register renaming, out-of-order issue/execution pipeline according to embodiments.

FIG. 16B is a block diagram illustrating both an exemplary embodiment of an in-order architecture core and an exemplary register renaming, out-of-order issue/execution architecture core to be included in a processor according to embodiments.

FIG. 17 illustrates a block diagram of an SOC (System On Chip) package in accordance with an embodiment.

FIG. 18 is a block diagram of a processing system, according to an embodiment.

FIG. 19 is a block diagram of an embodiment of a processor having one or more processor cores, according to some embodiments.

FIG. 20 is a block diagram of a graphics processor, according to an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

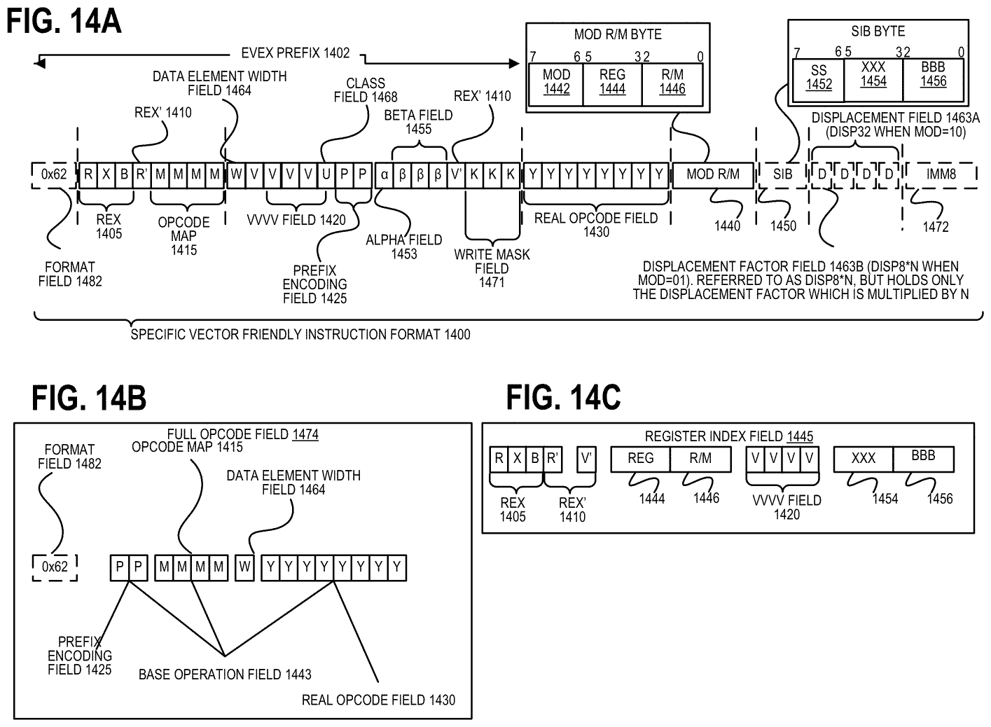

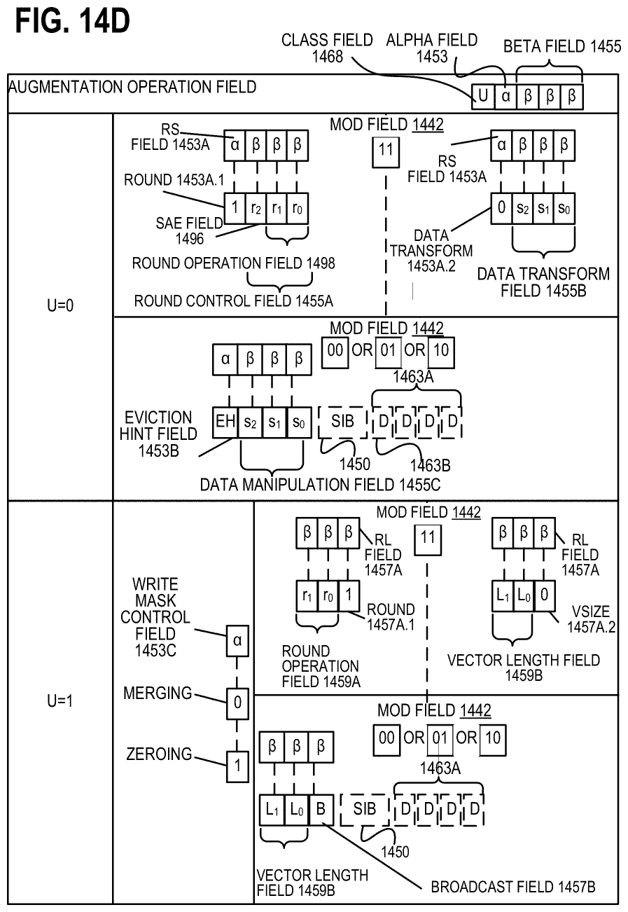

Some embodiments provide one or more techniques for provision of platform sealing secrets using a Physically Unclonable Function (PUF) with Trusted Computing Based (TCB) recoverability. For example, an embodiment wraps secrets and ties them to the platform using PUF derived key(s) while supporting TCB recoverability. As discussed herein, “wrapping” or “key wrapping” generally refers to the act of protecting an item by cryptographic techniques (such as encryption and/or integrity protection) using a key or secret. In at least some embodiments, one or more of the instructions discussed herein may follow the EVEX format (such as discussed with reference to FIGS. 14A-14D).

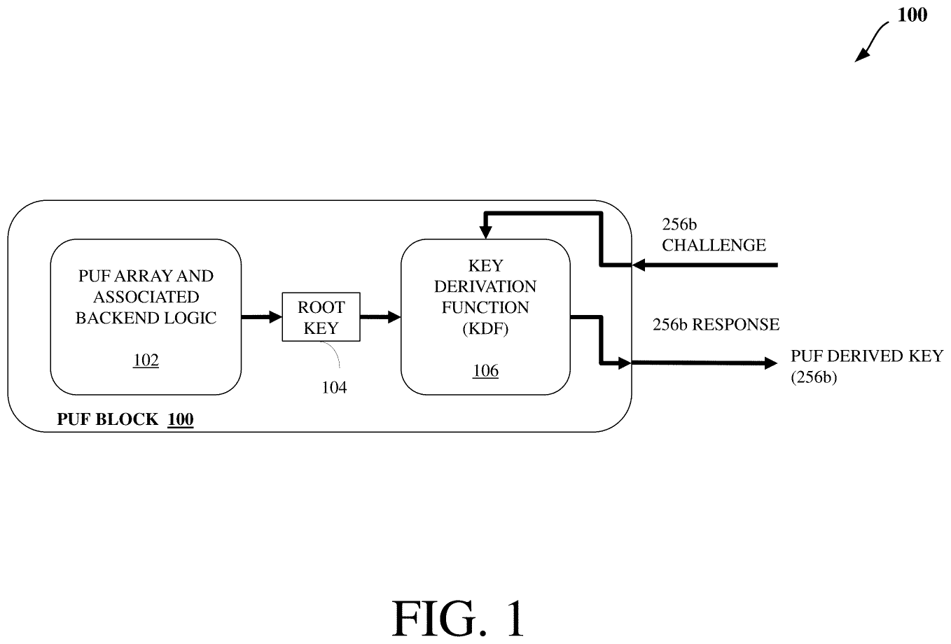

FIG. 1 illustrates a block diagram of a Physically Unclonable Function (PUF) component 100 which may be utilized in an embodiment. Generally, a PUF provides platform unique entropy which can be used to generate cryptographic keys as shown in FIG. 1. For example, on a platform reset or another triggering event, the PUF array logic 102 generates a platform unique entropy 104 (or root key as shown in FIG. 1). For example, another triggering even may be provided on demand in other embodiments where the PUF circuit receives an external input to start key generation. As discussed herein, “entropy” generally refers to a (e.g., random) key or object used in cryptographic algorithms that require a key.

In an embodiment, the platform unique entropy 104 is static, i.e., stays the same value generated across boots or triggering events, and is unique to the platform (i.e., the same PUF circuit used on a different platform will generate a different entropy). Traditionally, platform secrets have been stored in fuses and deemed secure. However, recent studies have shown that a determined hardware attacker can scan the fuses (e.g., using X-ray or the techniques), thereby recovering the secrets. PUF would provide protection against such scanning and its logic may come equipped with mechanisms that could also be resistant to side channel attacks (such as attacks using electromagnetic (EM) radiation).

In some embodiments, the root key 104 is not directly used but instead is used to derive other keys (e.g., by a Key Derivation Function (KDF) logic 106). In one embodiment the KDF 106 may utilize a National Institute of Standards and Technology (NIST) standard for deriving the keys. The derived keys may then act as the root keys for different usages. Accordingly, PUF can provide enhanced security against hardware attacks and a platform binding, as the key(s) generated are based on unique physical variations which occur during manufacturing on each platform. As shown in FIG. 1, the key(s), challenge(s), and response(s) may include 256 bits, but embodiments are not limited to this and more or less bits may be used. PUF may be used for protecting platform secrets (e.g., keys in fuses) and may generally not be exposed to software.

In some implementations, Software-Visible PUF (SV-PUF) exposes the PUF functionality to software through one or more instructions (also referred to herein collectively as ISA (Instruction Set Architecture)). At least one embodiment uses SV-PUF for wrapping secrets and tying them to the platform using PUF derived keys, which may also support Trusted Computing Base (TCB) recoverability. As discussed herein, “TCB” generally refers to all components of the platform or system that are critical to its security, such that a bug or vulnerability in the TCB might jeopardize the security of the entire system. More specifically, a bug in the TCB (which may include several firmware components such as security engine firmware (involved in deriving the PUF root key), ucode or microcode (involved in the wrapping and unwrapping of software secrets), power management firmware, etc.) can potentially result in revealing the SV-PUF root key or software secrets. Such bugs are fixed in the respective component and an update patch is released to be applied to affected systems.

With TCB recoverability, an update in TCB version number (also known as the security version number or SVN) can be communicated to the software and the secrets migrated from the old TCB to the new TCB to allow them to be protected with the new TCB. An attempt by an attacker to rollback to old SVN renders the secrets unusable. Without any TCB recoverability and migration, an attacker can potentially cause a rollback to an old TCB version with a bug which can result in revealing secrets.

To this end, an embodiment wraps secrets and ties them to the platform using PUF derived key(s) while supporting TCB recoverability. Software can generate a blob (or more generally (e.g., large) data, a (e.g., large binary) object, etc.) which would only work when it is generated with the current TCB, or works with the old TCB version number with a warning to indicate to the software to rewrap secrets with the current TCB (also referred to as migrating to a new TCB). An instruction is introduced to support recoverable sealed blobs in an embodiment.

One embodiment provides software the capability to wrap secrets using PUF-derived keys tied to a TCB version. These secrets may be made available across boots without ever exposing them in open or unprotected memory. This is done by introducing new instructions for wrapping/unwrapping which support TCB recoverability. Wrapping instruction takes the software secret as an input operand and wraps it, i.e., encrypts and integrity protects it, using a PUF-derived key. The wrapped blobs generated are tied to a particular usage. For some embodiments, a blob can be generated simply to protect a secret which software intends to retrieve at a later point in time or a blob can be generated to protect keys that need to be programmed to a cryptographic engine. As an example, Multi-Key Total Memory Encryption (MKTME) keys for persistent memory can be protected using these new instructions. Similarly Total Storage Encryption (TSE) engine keys can be protected with these new instructions.

Moreover, in order to use the secrets available in wrapped blobs, another embodiment provides an unwrapping instruction which takes the wrapped blob as an input parameter and unwraps the secret, i.e., decrypts and verifies the integrity of the secret. The retrieved secret is then returned to the software or programmed to a hardware engine depending on the intended usage, which may be indicated by software to the ISA at the time of wrapping. The wrapping instruction optionally allows platform and/or CPU (Central Processing Unit, also referred to as “processor” herein) configuration to be included in the wrapping. In one embodiment, the unwrapping instruction will allow a blob to be unwrapped only if the platform and/or CPU configuration (desired at the time of wrapping) is active at the time of unwrapping.

In the event of bugs in the TCB, a TCB update can result in making blobs generated with previous TCBs (with potential security bugs) unusable by preventing unwrapping of the recoverable blobs. Optionally, software can also choose to generate blobs which work with old TCB but provide a warning when the TCB version has changes (new TCB installed). The software can then migrate to the new TCB by performing the wrapping again with the new TCB. This may be done by enhancing the wrapping instruction to allow the security engine generating/managing the PUF derived key to return the current TCB version in the wrapped blob. Software is then expected to provide the wrapped blob along with the TCB version with which it was generated to allow unwrapping. The unwrapping may then work based on the software policy as discussed earlier.

Hence, PUF circuits/logic can provide strong protection against hardware attacks and some embodiments allow this protection to be afforded to software secrets as well. Additionally, the secrets are never exposed in plaintext to memory or otherwise exposed to unprotected memory, or only exposed when they are explicitly requested by owning software, minimizing the exposure to attacks. One or more embodiments afford unknowable key capability to a hardware maker, i.e., the software key is never known to the hardware manufacturer and neither is the PUF derived key that is used to protect the secret. This support may be afforded while allowing for TCB recoverability enhancing the security of wrapped blobs in case of TCB bugs which may happen invariably.

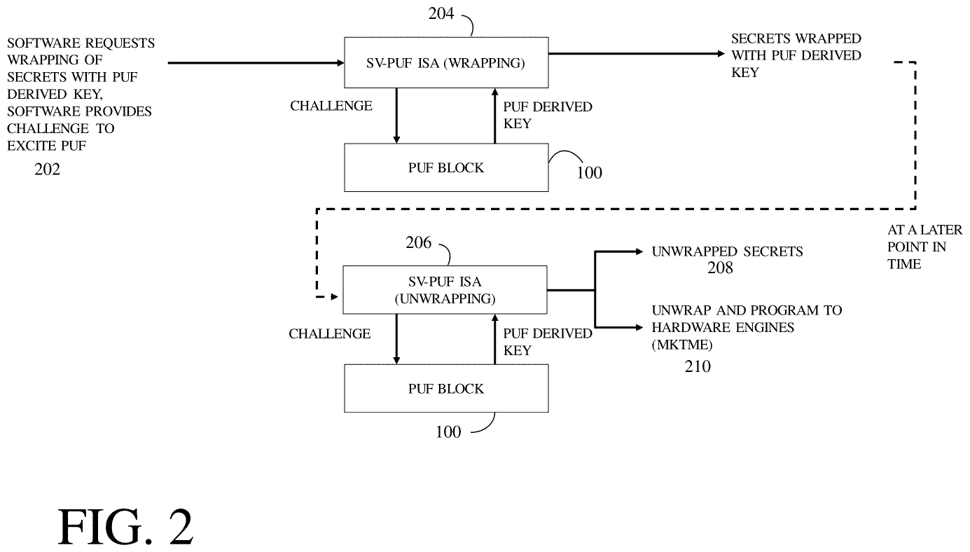

FIG. 2 illustrates a block diagram of various components used to wrap and/or unwrap using SV-PUF instruction(s), according to one or more embodiments. Initially, software requests wrapping of secrets using a PUF derived key by using the wrapping instruction disclosed herein (202). In addition to providing the secret to wrap, the software also provides a challenge which is used to generate a PUF derived key from the root PUF key. As discussed herein, “secret to wrap” may interchangeably refer to “data to be cryptographically protected.” Software may also include a policy for recoverability. Some embodiments support at least two policies: (1) allow unwrapping with old TCB version with a warning; and/or (2) disallow unwrapping with old TCB, and error out.

AT 204, the wrapping instruction takes the input provided by software in a memory structure and excites/triggers the PUF circuit 100 to obtain the key to use. The security engine managing the PUF engine may also return a security version number to reflect the version number of the TCB to the ucode. On retrieving the key from PUF and the current SVN, the wrapping instruction can use this key to encrypt and integrity protect the secret provided by software. In an embodiment, the wrapped blob includes the SVN used for wrapping and is returned to the software in a memory location provided by software.

At a later point in time when software intends to use the blob, it does so using the unwrapping instruction at 206. The unwrapping instruction may include multiple instructions, one for each of the usages disclosed. For example, the first instruction takes the wrapped blob along with the TCB version used to generate the blob, retrieves the secret by checking the integrity of the blob and decrypting it. The retrieved secret is then returned back to software (208). Another usage disclosed involves programming hardware cryptographic engines with the keys. As an example, a persistent memory key could be programmed to the MKTME engine using a wrapped blob. In this case, the instruction for programming the engine takes the wrapped blob along with the TCB version used to generate the blob, unwraps it as discussed before (but may not return the retrieved key(s) to software). Instead the key may be programmed directly to the target hardware engine(s) over a hardware interface at 210, thereby not exposing the key(s) in plaintext in memory or otherwise to unprotected memory. In an embodiment, the unwrapping only succeeds if the version number included with the blob is the same as the current SVN. If the TCB has been updated, the unwrapping errors out or gives a warning depending on the recoverability policy chosen at wrapping time. The next two sections describe the usages and the instructions disclosed in accordance with various embodiments.

### Sealing/Unsealing Using SV-PUF

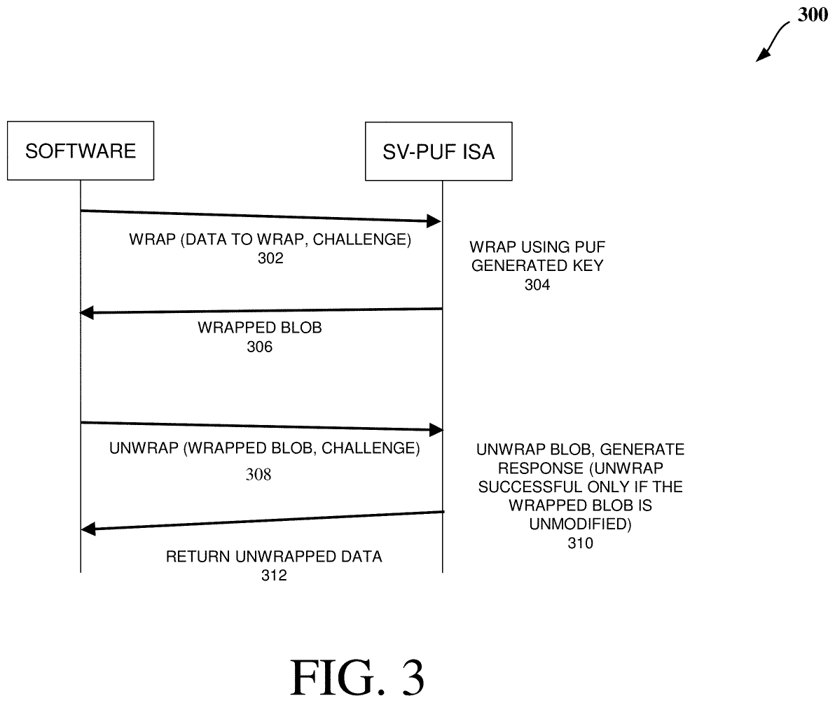

FIG. 3 illustrates a flow diagram of a method 300 for software sealing/unsealing of secrets using SV-PUF, according to an embodiment. At operation 302, software requiring to protect secrets invokes a new instruction, WRP, passing the data to wrap as an input operand along with a challenge which is used as an input to the PUF circuit (e.g., PUF block 100 discussed with reference to FIGS. 1-2) to generate a PUF-derived unique key (the PUF root key may be mixed with this challenge using a KDF as previously discussed). In an embodiment, the PUF circuit itself can provide multiple root keys for different usages. As an example, there can be one root key derived for standard platform usages (e.g., protecting fuses) and another root key for SV-PUF usages, but for the sake of simplicity this disclosure refers to one root key. The wrap instruction uses the challenge to obtain the PUF derived key along with the current SVN from the security engine managing/hosting the PUF engine and uses it to encrypt and integrity protect the secret requested (304). The wrapped blob (e.g., including the SVN used for wrapping) is provided as an output of the instruction and stored in a memory location, e.g., specified by software and provided as an input to the wrap instruction (306).

In an embodiment, software keeps the blob around (e.g., in a memory location as defined by software such as a disk, on a network storage, etc.) when the secret it protects is not in use. At an operation 308, e.g., when the software needs access to the secrets, software executes a new instruction, UNWRP, with the wrapped blob passed as an input operand. In an embodiment, the wrapped blob is provided with the same SVN that was returned during wrapping to allow for successful unwrapping. The UNWRP instruction uses the challenge passed along with the blob to excite/trigger the PUF circuit to retrieve the PUF derived key that was used to wrap the blob (310). The SVN is also provided to the security engine hosting the PUF to allow it to perform an SVN check. The PUF derived key is then used to decrypt the wrapped blob and verify its integrity. If the integrity verification is successful and the current SVN is the same as the SVN at the time of wrapping, the unwrapped data is returned back to requesting software at operation 312; otherwise, the unwrapping generates a warning or error out depending on the recoverability policy chosen at the time of wrapping. The challenge used to excite PUF may be a 256b random value chosen by the software and it is provided for wrapping and unwrapping.

### Cryptographic Key Programming Using SV-PUF

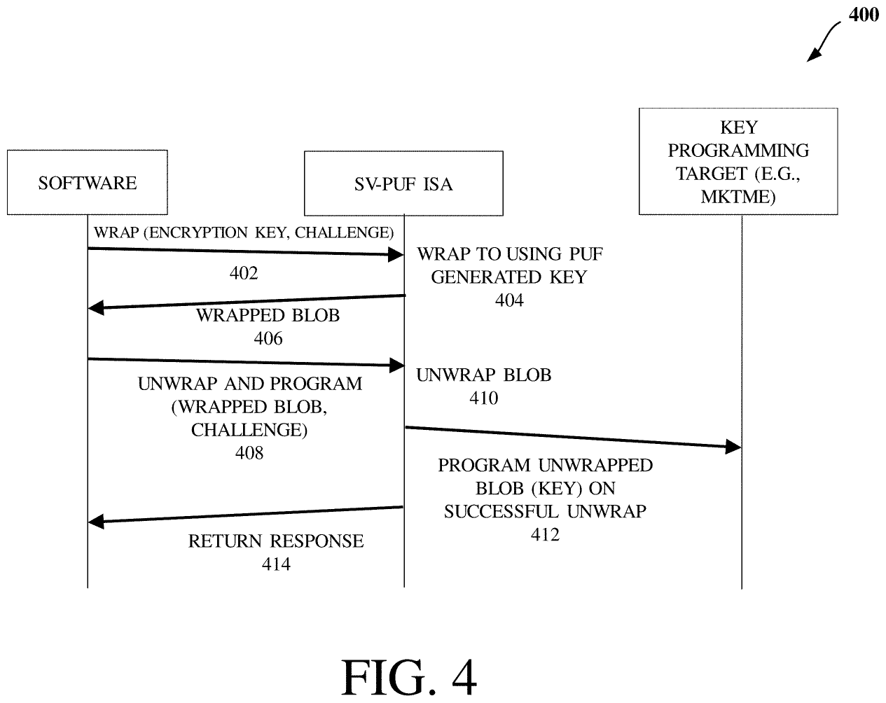

FIG. 4 illustrates a flow diagram of a method 400 for cryptographic key programming using SV-PUF, according to an embodiment.

With the key programming usage, software intends to program a key to a hardware block on the platform. One example usage is programming keys for persistent memory to the MKTME engine. In this usage, during provisioning phase, which can happen when a user receives a machine at an information technology center in an enterprise environment, the key to be used for persistent memory encryption (can be equated to disk encryption) is wrapped using a PUF derived key similar to the wrap usage described above. Operations 402, 404, 406, and 408 may use the WRP/UNWRP instructions as previously discussed.

In an embodiment, when software wants to program the key (e.g., on each reboot to set up the persistent memory key), software invokes an instruction, PCONFIG, to use the wrapped blob to program the key (410). The PCONFIG instruction unwraps the blob and as before verifies the integrity but in this usage (instead of returning the unwrapped secret back to software), the key is programmed to the target hardware engine over a hardware interface (412). In this way, the key is not exposed in memory beyond the provisioning phase, which can occur only once during the lifetime of a machine. A response of successful/failed programming is returned to requesting software (414).

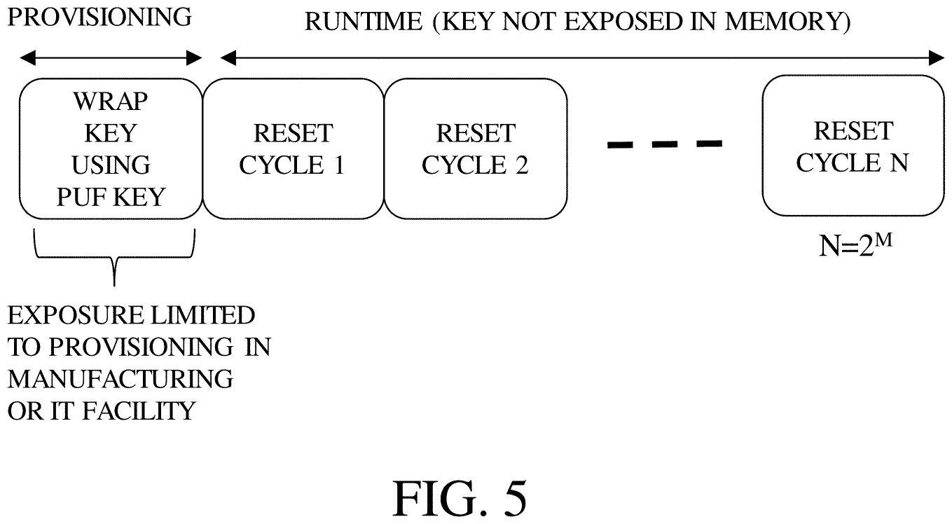

FIG. 5 illustrates the security value in terms of exposure of the keys with SV-PUF according to an embodiment. In other words, FIG. 5 shows the limited exposure to provisioning with SV-PUF. As shown, exposure is only limited to the provisioning stage (e.g., during manufacturing or at an information technology facility). During runtime, the key is not exposed to unprotected memory or in plaintext (i.e., unencrypted), no matter the number of triggering/reset cycles. As shown in FIG. 1, N reset cycles may be used, e.g., with N=2^{M}, where M is the key length in bits.

In at least one embodiment, the recoverability aspects for this usage are the same as described for the wrapping/unwrapping usage. Software needs to provide a wrapping policy at the time of wrapping which is then used by unwrapping instruction to determine if unwrapping can be done successfully. Depending on the recoverability policy chosen, the unwrapping will either provide a warning to software or error out if the current SVN of the TCB for PUF wrapping is not the same as the TCB of the wrapped blob.

### ISA Support for Sealing/Unsealing to Software/Hardware Cryptographic Engine

In some embodiments, there are three new instructions disclosed herein:

(1) Wrapping Support: WRP, an instruction to allows software to wrap secret information with wrapping key and bind it to a specified target with recoverability policy as an input;

(2) Unwrapping Support: UNWRP, an instruction to allow conditional unwrapping from WRP generated wrapped blobs based on the current security version number or TCB version; and

(3) Hardware Key Programming Support: PCONFIG, an instruction to allow software to program keys and other target-specific information to desired targets, e.g., conditioned on the current security version number or TCB version.

In an embodiment, the wrapping target and hardware key programming target can be defined as follows:

(a) Wrapping target: software requests wrapping by specifying a target which is used to indicate the usage software is requesting the blob to be generated. For seal/unseal (also referred to as wrap/unwrap) usage, there is one target which indicates to the ISA that the unwrapped secrets are to be returned back to software. For hardware key programming, there is a different target which indicates to the ISA that the unwrapped secrets are to be programing to a desired hardware engine. The wrapping target is checked in the unwrapping instructions (UNWRP and PCONFIG).

(b) Hardware programming target: This target reflects the hardware engine to which the key needs to be programmed. MKTME and TSE engines are used as example hardware engines in this disclosure.

In an embodiment, some sample details of WRP instruction include:
Ring-0 instruction, 64b
Software invokes WRP by passing an input and an output memory buffer
   Current usages take BIND_STRUCT as the input and output structure (discussed next)
Operands:
   RAX: Operation Status
   RBX: Linear address of input memory buffer
   RCX: Linear address of output memory buffer
Flags Affected:
   ZF cleared on successful unwrap, ZF set to 1 otherwise
   CF, PF, AF, OF, and SF are cleared

As discussed herein, RAX, RBX, and RCX refer to general-purpose registers. As discussed with reference to FIG. 2, software initially requests wrapping of secrets using a PUF derived key by using the WRP instruction. In addition to providing the secret to wrap, the software may also provide a challenge. As discussed herein, “secret to wrap” may interchangeably refer to “data to be cryptographically protected.”

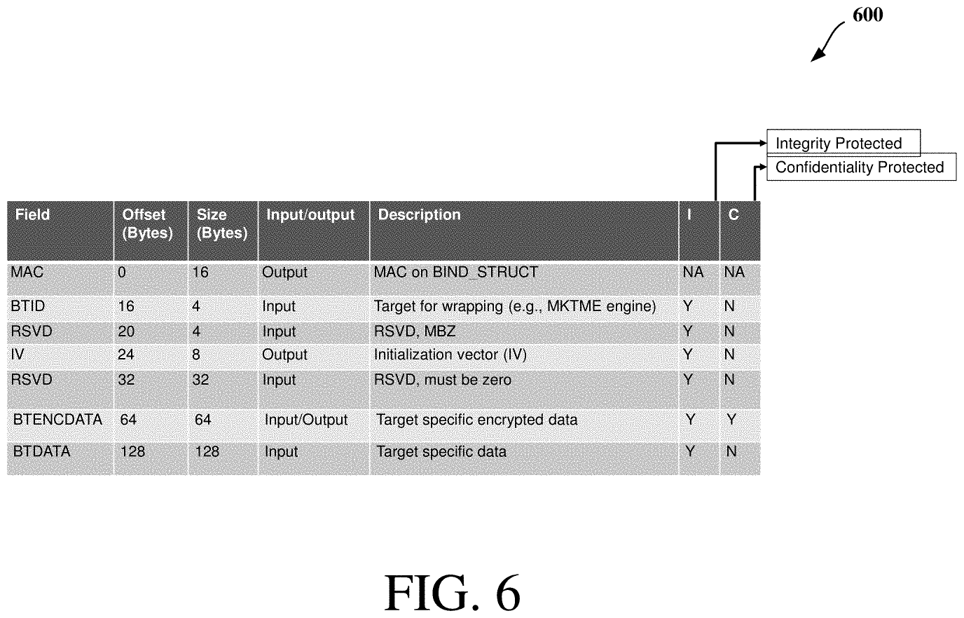

FIG. 6 illustrates a BIND-STRUCT structure 600, according to an embodiment. As shown, WRP operates using BIND_STRUCT as the input/output structure which allows specification of target-specific data.

In accordance with an embodiment, the following describe the fields of the structure of FIG. 6:

MAC: Message Authentication Code over the output wrapped structure generated by WRP

BTID: Target for wrapping. There are three targets for the usages disclosed in this invention, WRAP_DATA_CPU, MKTME_ENGINE_SVPUF, and TSE_ENGINE_SVPUF

SEQID: initialization vector used for authenticated encryption performed by the instruction

BTENCDATA: This field carries the secrets that software wants to be wrapped

BTDATA: This field carries information such as a challenge to be used to excite/trigger PUF and a configuration vector to indicate to the instruction, the platform, and CPU configuration that needs to be included for wrapping. In addition, this field may carry the recoverability policy to be used. In an example implementation, two policies are supported, error out on unwrapping if the SVN used for generating the blob does not match the current SVN or give a warning to software to allow it to perform the migration from old TCB to the new TCB. This field may also carry the SVN at the time of wrapping and include it integrity-protected in the wrapped blob.

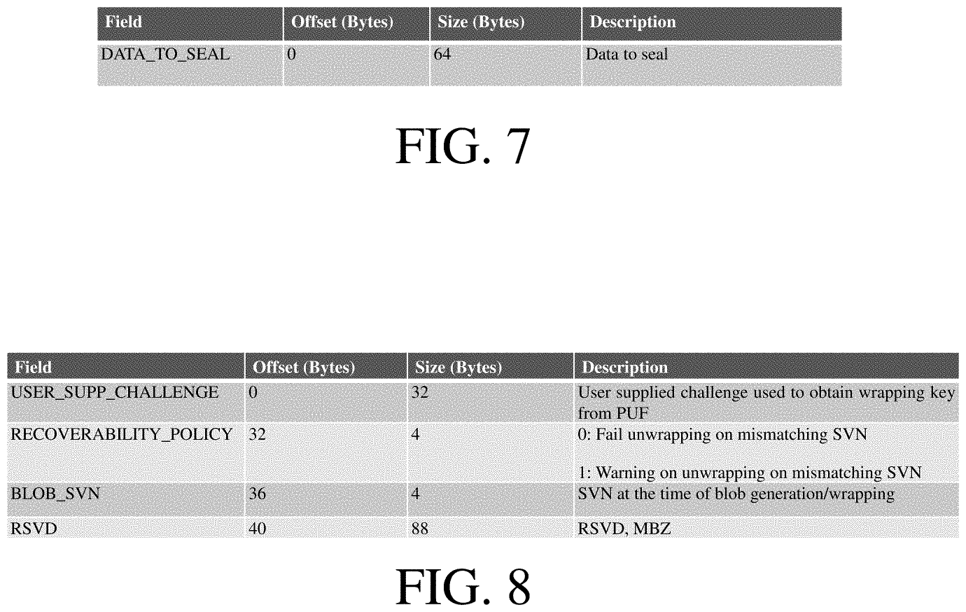

FIG. 7 shows further details of the BTENCDATA field from FIG. 6, according to an embodiment. As shown BTENCDATA can be a single 64B field which software can populate as desired to carry keys or other secrets it wants to protect. As an example, for MKTME/TSE key programming, this field carries two keys, data and tweak key to be used for encryption using AES (Advanced Encryption Standard) in XTS (XEX-based Tweakable-codebook mode with ciphertext Stealing) mode. Each key can be up to 256b in size. In an embodiment, software can cryptographically protect any amount of data using a key and then use SV-PUF ISA to protect the key, thereby allowing an arbitrarily large amounts of data to be protected with SV-PUF.

FIG. 8 illustrates a sample table for the BTDATA field of FIG. 6, according to an embodiment. This field carries other sub-fields which control the wrapping using the PUF derived key. One embodiment introduces RECOVERABILITY_POLICY as a new field in addition to the challenge used to generate the PUF-derived key and a bit vector to carry platform/CPU configuration to bind to. The configuration used to bind to and the mechanism to do so is discussed next.

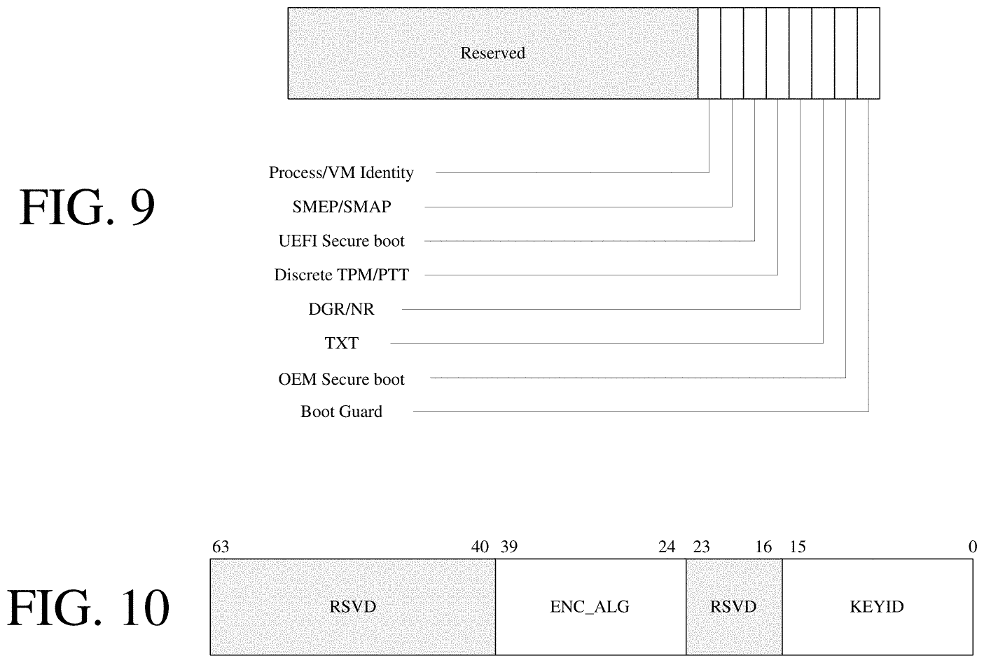

FIG. 9 shows the platform/CPU configuration to which the wrapped blobs can be bound, according to an embodiment. WRP instruction ucode may use this bit vector in wrapping and bind the blob to this configuration by simply including it in the message authentication code (MAC) generated on the output BIND_STRUCT. In general, WRP may not perform any checks, the unwrapping instructions will do the checks for configurations and only allow unwrapping if the configuration that software desired is active. Hence, software is to check the current configuration on the machine before requesting binding to ensure that it does not bind secrets to configuration which is not active on the platform. Binding done to such configuration will result in blobs that cannot be unwrapped to retrieve the secrets. As an example, if boot guard is not enabled and software requested binding assuming boot guard enabled, the UNWRP instruction will check whether boot guard is enabled or not and disallow unwrapping the blob as the configuration that software requested at wrapping time is not present at unwrapping time.

In FIG. 9, VM stands for Virtual Machine, SMEP refers to Supervisory Mode Execution Prevention, SMAP refers to Supervisory Mode Access Prevention, UEFI stands for Unified Extensible Firmware Interface, TPM refers to Trusted Platform Module, PTT refers to Platform Trusted Technology, DGR stands for Devil's Gate Rock, NR stands for Nifty Rock, TXT stands for Trusted Execution Technology, OEM refers to Original Equipment Manufacturer, and Boot guard refers to an optional processor feature to prevent replacement of firmware to protect the system before secure boot starts.

As another example of configuration, wrapping to the software identity (e.g., process identity, enclave measurement, VM/TD (Virtual Machine/Trusted Domain) measurement) is allowed. The WRP instruction, if requested to bind to the identity of the software, picks the identity from hardware and includes it in the MAC generated. On unwrapping, the unwrapping instruction uses the identity form hardware to verify the MAC. If software unwrapping a blob does not own the blob, the unwrapping will fail, thereby binding to the software identity. Moreover, in an embodiment, only the software that originally wrapped the blob can use it to recover the unwrapped secret as the blob is bound to the identity (or measurement) of that software.

In an embodiment, for recoverability, the WRP instruction in addition to obtaining the PUF derived key (based on challenge provided) also obtains the current SVN from the PUF management engine (e.g., hardware/firmware). This SVN includes the SVN of the TCB components such as ucode and any other firmware that has access to the PUF derived key or root key used for deriving the key (e.g., security engine firmware, power management firmware). The WRP instruction after retrieving the SVN will integrity protect it along with the other fields in the output blob.

In an embodiment, the UNWRP instruction takes the wrapped blob for seal/unseal usage where software has returned the secret after unwrapping. If a different usage blob (indicated by BTID field of FIG. 6) is passed to UNWRP, the unwrapping will fail. Note that at wrapping time, the BTID is included as part of the MAC and hence untrusted software cannot just change the BTID to use blob for one usage for another usage. In other words, the WRP instruction ensures binding to the target/usage.

In an embodiment, some sample details of UNWRP instruction include:
Ring-0 instruction, 64b
Software invokes UNWRAP by passing wrapped blob generated using WRP and a pointer to output buffer to receive unwrapped data
   Unwraps blob successfully as long as correct challenge is provided and the current SVN as known to the PUF manager is the same as the SVN provided in the wrapped blob (SVN at the time of wrapping)
Operands:
   RAX: Operation status
   RBX: Linear address of input wrapped BIND_STRUCT
   RCX: Linear address of output buffer to receive unwrapped data
Flags Affected:
   ZF cleared on successful unwrap, ZF set to 1 otherwise
   CF, PF, AF, OF, and SF are cleared

With respect to the PCONFIG.MKTME_KEY_PROGRAM_SVPUF leaf, the PCONFIG instruction may have initially been used with MKTME to program the keys to the MKTME engine: (a) software invokes the appropriate function by setting the MKTME key programming leaf value in EAX; (b) RBX, RCX, and RDX have leaf-specific usage; and (c) Operation status indicated in EAX. Hence, only one leaf function (MKTME_KEY_PROGRAM) may be supported with this version of PCONFIG.

In an embodiment, SV-PUF introduces a new PCONFIG leaf to support MKTME key programming using wrapped blobs. While an embodiment proposes an additional leaf to PCONFIG instruction, this could be made more generic as a new instruction. Additionally, while the MKTME engine may be referred to herein as an example, a similar flow may also be used for the Total Storage Encryption (TSE) engine, either as a new leaf to PCONFIG or a new instruction. The new leaf or new instruction may target the TSE engine for programming and expect a wrapped blob with TSE as the target.

In one embodiment, the PCONFIG leaf for MKTME programming using PUF wrapped blob is executed with the following parameters: (1) EAX: MKTME_KEY_PROGRAM_SVPUF; (2) RBX: KEYID_CTRL (shown in FIG. 10, e.g., which may be the same as defined for MKTME); and (3) RCX: Linear address of wrapped WRAPPED_KEY_PROGRAM_STRUCT.

More particularly, FIG. 10 illustrates a sample 64-bit KEYID_CTRL for MKTME programming, according to an embodiment. The recoverability actions may be the same as described for the previous usage. In FIG. 10, KEYID refers to key identifier and ENC_ALG refers to Encryption Algorithm (to use with the KeyID).

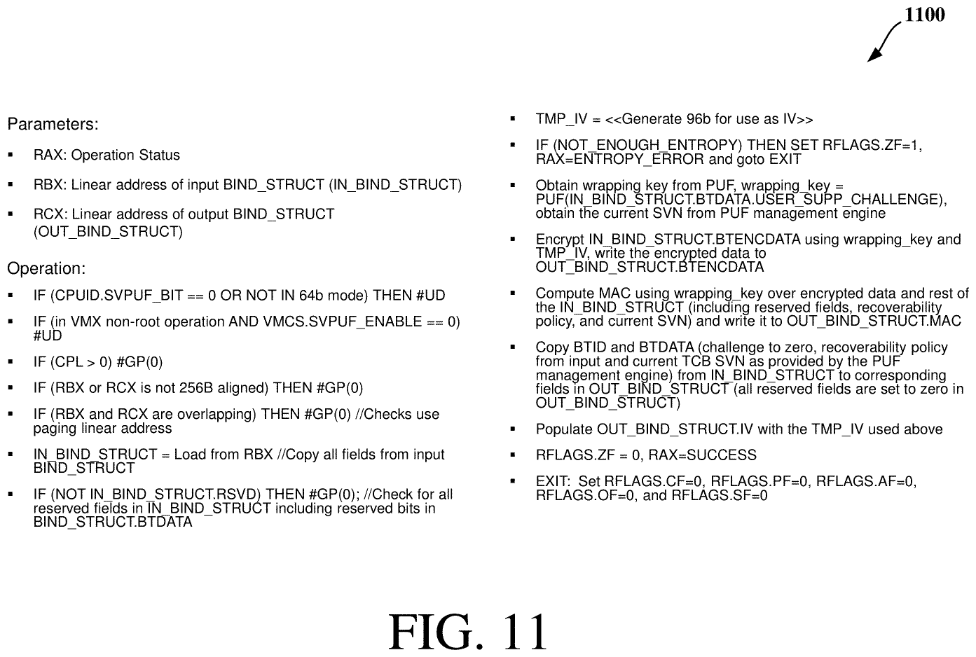

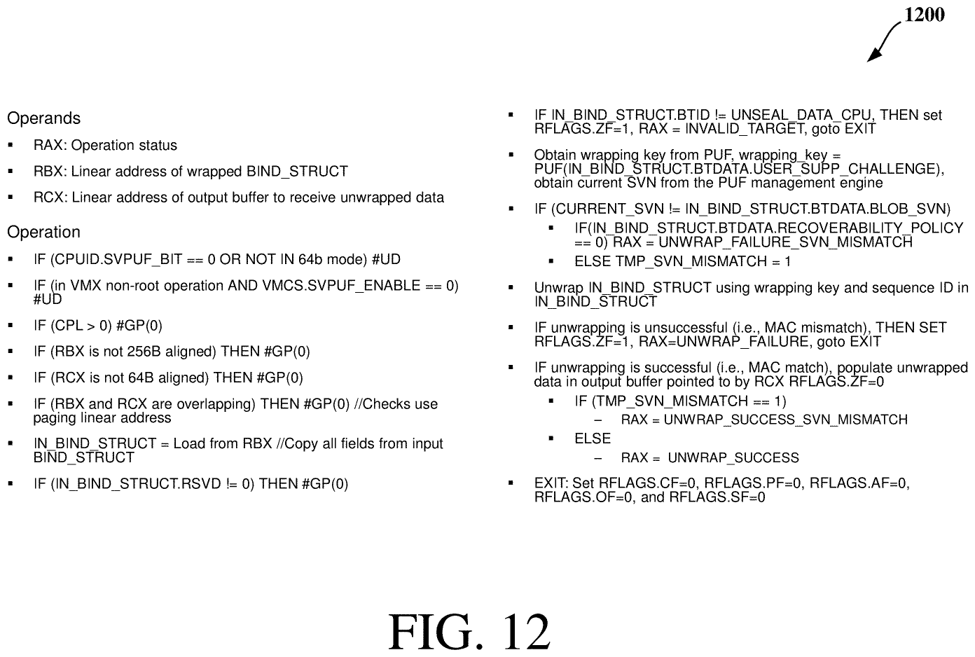

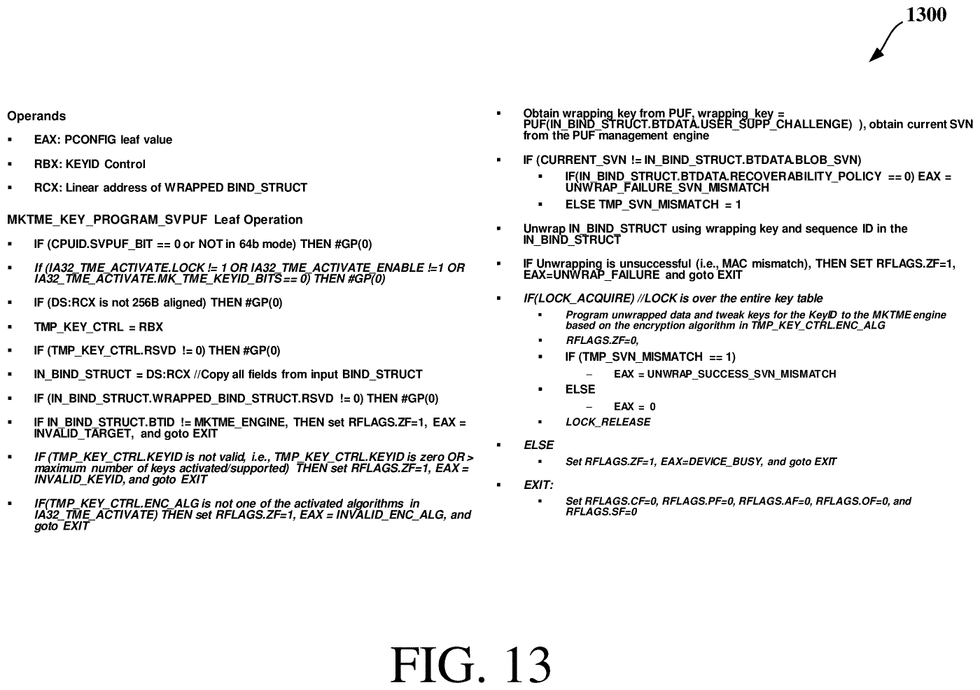

FIG. 11 shows a sample pseudocode 1100 for the WRP instruction, according to an embodiment. FIG. 12 shows a sample pseudocode 1200 for the UNWRP instruction, according to an embodiment. FIG. 13 shows a sample pseudocode 1300 for the PCONFIG.MKTME_KEY_PROGRAM_SVPUF instruction, according to an embodiment.

Referring to FIGS. 11, 12, and 13, one or more of the WRP, UNWRP, and PCONFIG.MKTME_KEY_PROGRAM_SVPUF leaf are enumerated in extended features in CPUID (CPU identifier), e.g., when 0, WRP and UNWRP will #UD (or Undefined Opcode) and PCONFIG.MKTME_KEY_PROGRAM_SVPUF leaf will #GP(0) (or General Protection fault). Various terms used in the pseudocodes are referred to herein with reference to the other figures.

Also, while some embodiments use PUF as an example of platform unique persistent entropy, embodiments are not limited to this and any other persistent entropy source may be utilized. As an example, the platform root key can be stored in fuses or derived out of fuses on each boot. However, alternate implementations using other sources of persistent entropy may have different security profiles (e.g., defense against hardware attacks may be lower with a fuse-based key).

Additionally, some embodiments may be applied in computing systems that include one or more processors (e.g., where the one or more processors may include one or more processor cores), such as those discussed with reference to FIG. 1 et seq., including for example a desktop computer, a work station, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Instruction Sets

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, September 2014; and see Intel® Advanced Vector Extensions Programming Reference, October 2014).

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

While embodiments will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 256 byte vector operands) with more, less, or different data element widths (e.g., 128 bit (16 byte) data element widths).

FIG. 14A is a block diagram illustrating an exemplary instruction format according to embodiments. FIG. 14A shows an instruction format 1400 that is specific in the sense that it specifies the location, size, interpretation, and order of the fields, as well as values for some of those fields. The instruction format 1400 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions.

EVEX Prefix (Bytes 0-3) 1402—is encoded in a four-byte form.

Format Field 1482 (EVEX Byte 0, bits [7:0])—the first byte (EVEX Byte 0) is the format field 1482 and it contains 0x62 (the unique value used for distinguishing the vector friendly instruction format in one embodiment).

The second-fourth bytes (EVEX Bytes 1-3) include a number of bit fields providing specific capability.

REX field 1405 (EVEX Byte 1, bits [7-5])—consists of a EVEX.R bit field (EVEX Byte 1, bit [7]-R), EVEX.X bit field (EVEX byte 1, bit [6]-X), and 1457 BEX byte 1, bit[5]-B). The EVEX.R, EVEX.X, and EVEX.B bit fields provide the same functionality as the corresponding VEX bit fields, and are encoded using 1 s complement form, i.e., ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field QAc10—this is the EVEX.R′ bit field (EVEX Byte 1, bit [4]—R′) that is used to encode either the upper 16 or lower 16 of the extended 32 register set. In one embodiment, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative embodiments do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 1415 (EVEX byte 1, bits [3:0]-mmmm)—its content encodes an implied leading opcode byte (0F, 0F 38, or 0F 3).

Data element width field 1464 (EVEX byte 2, bit [7]-W)—is represented by the notation EVEX.W. EVEX.W is used to define the granularity (size) of the datatype (either 32-bit data elements or 64-bit data elements). This field is optional in the sense that it is not needed if only one data element width is supported and/or data element widths are supported using some aspect of the opcodes.

EVEX.vvvv 1420 (EVEX Byte 2, bits [6:3]-vvvv)—the role of EVEX.vvvv may include the following: 1) EVEX.vvvv encodes the first source register operand, specified in inverted (1 s complement) form and is valid for instructions with 2 or more source operands; 2) EVEX.vvvv encodes the destination register operand, specified in 1 s complement form for certain vector shifts; or 3) EVEX.vvvv does not encode any operand, the field is reserved and should contain 1111b. Thus, EVEX.vvvv field 1420 encodes the 4 low-order bits of the first source register specifier stored in inverted (1 s complement) form. Depending on the instruction, an extra different EVEX bit field is used to extend the specifier size to 32 registers.

EVEX.U 1468 Class field (EVEX byte 2, bit [2]-U)—If EVEX.U=0, it indicates class A (support merging-writemasking) or EVEX.U0; if EVEX.U=1, it indicates class B (support zeroing and merging-writemasking) or EVEX.U1.

Prefix encoding field 1425 (EVEX byte 2, bits [1:0]-pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 1453 (EVEX byte 3, bit [7]-EH; also known as EVEX.EH, EVEX.rs, EVEX.RL, EVEX.writemask control, and EVEX.N; also illustrated with α)—its content distinguishes which one of the different augmentation operation types are to be performed.

Beta field 1455 (EVEX byte 3, bits [6:4]-SSS, also known as EVEX.s2-0, EVEX.r2-0, EVEX.rr1, EVEX.LL0, EVEX.LLB; also illustrated with βββ)—distinguishes which of the operations of a specified type are to be performed.

REX′ field 1410—this is the remainder of the REX′ field and is the EVEX.V′ bit field (EVEX Byte 3, bit [3]-V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Writemask field 1471 (EVEX byte 3, bits [2:0]-kkk)—its content specifies the index of a register in the writemask registers. In one embodiment, the specific value EVEX kkk=000 has a special behavior implying no writemask is used for the particular instruction (this may be implemented in a variety of ways including the use of a writemask hardwired to all ones or hardware that bypasses the masking hardware). When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the writemask field 1471 allows for partial vector operations, including loads, stores, arithmetic, logical, etc. While embodiments are described in which the writemask field's 1471 content selects one of a number of writemask registers that contains the writemask to be used (and thus the writemask field's 1471 content indirectly identifies that masking to be performed), alternative embodiments instead or additional allow the mask write field's 1471 content to directly specify the masking to be performed.

Real Opcode Field 1430 (Byte 4) is also known as the opcode byte. Part of the opcode is specified in this field.

MOD R/M Field 1440 (Byte 5) includes MOD field 1442, register index field 1444, and R/M field 1446. The MOD field's 1442 content distinguishes between memory access and non-memory access operations. The role of register index field 1444 can be summarized to two situations: encoding either the destination register operand or a source register operand, or be treated as an opcode extension and not used to encode any instruction operand. The content of register index field 1444, directly or through address generation, specifies the locations of the source and destination operands, be they in registers or in memory. These include a sufficient number of bits to select N registers from a P×Q (e.g., 32×512, 16×128, 32×1024, 64×1024) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination).

The role of R/M field 1446 may include the following: encoding the instruction operand that references a memory address, or encoding either the destination register operand or a source register operand.

Scale, Index, Base (SIB) Byte (Byte 6)—The scale field's 1450 content allows for the scaling of the index field's content for memory address generation (e.g., for address generation that uses 2scale*index+base). SIB.xxx 1454 and SIB.bbb 1456—the contents of these fields have been previously referred to with regard to the register indexes Xxxx and Bbbb.

Displacement field 1463A (Bytes 7-10)—when MOD field 1442 contains 10, bytes 7-10 are the displacement field 1463A, and it works the same as the legacy 32-bit displacement (disp32) and works at byte granularity. This may be used as part of memory address generation (e.g., for address generation that uses 2scale*index+base+displacement).

Displacement factor field 1463B (Byte 7)— when MOD field 1442 contains 01, byte 7 is the displacement factor field 1463B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 1463B is a reinterpretation of disp8; when using displacement factor field 1463B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 1463B substitutes the legacy x86 instruction set 8-bit displacement. Thus, the displacement factor field 1463B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset).

Immediate field 1472 allows for the specification of an immediate. This field is optional in the sense that is it not present in an implementation of the generic vector friendly format that does not support immediate and it is not present in instructions that do not use an immediate.

### Full Opcode Field

FIG. 14B is a block diagram illustrating the fields of the instruction format 1400 that make up the full opcode field 1474 according to one embodiment. Specifically, the full opcode field 1474 includes the format field 1482, the base operation field 1443, and the data element width (W) field 1463. The base operation field 1443 includes the prefix encoding field 1425, the opcode map field 1415, and the real opcode field 1430.

### Register Index Field

FIG. 14C is a block diagram illustrating the fields of the format 1400 that make up the register index field 1445 according to one embodiment. Specifically, the register index field 1445 includes the REX field 1405, the REX′ field 1410, the MODR/M.reg field 1444, the MODR/M.r/m field 1446, the VVVV field 1420, xxx field 1454, and the bbb field 1456.

### Augmentation Operation Field

FIG. 14D is a block diagram illustrating the fields of the instruction format 1400 that make up an augmentation operation field according to one embodiment. When the class (U) field 1468 contains 0, it signifies EVEX.U0 (class A 1468A); when it contains 1, it signifies EVEX.U1 (class B 1468B). When U=0 and the MOD field 1442 contains 11 (signifying a no memory access operation), the alpha field 1453 (EVEX byte 3, bit [7]-EH) is interpreted as the rs field 1453A. When the rs field 1453A contains a 1 (round 1453A.1), the beta field 1455 (EVEX byte 3, bits [6:4]-SSS) is interpreted as the round control field 1455A. The round control field 1455A includes a one bit SAE field 1496 and a two bit round operation field 1498. When the rs field 1453A contains a 0 (data transform 1453A.2), the beta field 1455 (EVEX byte 3, bits [6:4]-SSS) is interpreted as a three bit data transform field 1455B. When U=0 and the MOD field 1442 contains 00, 01, or 10 (signifying a memory access operation), the alpha field 1453 (EVEX byte 3, bit [7]-EH) is interpreted as the eviction hint (EH) field 1453B and the beta field 1455 (EVEX byte 3, bits [6:4]-SSS) is interpreted as a three bit data manipulation field 1455C.

When U=1, the alpha field 1453 (EVEX byte 3, bit [7]-EH) is interpreted as the writemask control (Z) field 1453C. When U=1 and the MOD field 1442 contains 11 (signifying a no memory access operation), part of the beta field 1455 (EVEX byte 3, bit [4]-S0) is interpreted as the RL field 1457A; when it contains a 1 (round 1457A.1) the rest of the beta field 1455 (EVEX byte 3, bit [6-5]-S2-1) is interpreted as the round operation field 1459A, while when the RL field 1457A contains a 0 (VSIZE 1457.A2) the rest of the beta field 1455 (EVEX byte 3, bit [6-5]-S2-1) is interpreted as the vector length field 1459B (EVEX byte 3, bit [6-5]-L1-0). When U=1 and the MOD field 1442 contains 00, 01, or 10 (signifying a memory access operation), the beta field 1455 (EVEX byte 3, bits [6:4]-SSS) is interpreted as the vector length field 1459B (EVEX byte 3, bit [6-5]-L1-0) and the broadcast field 1457B (EVEX byte 3, bit [4]-B).

### Exemplary Register Architecture

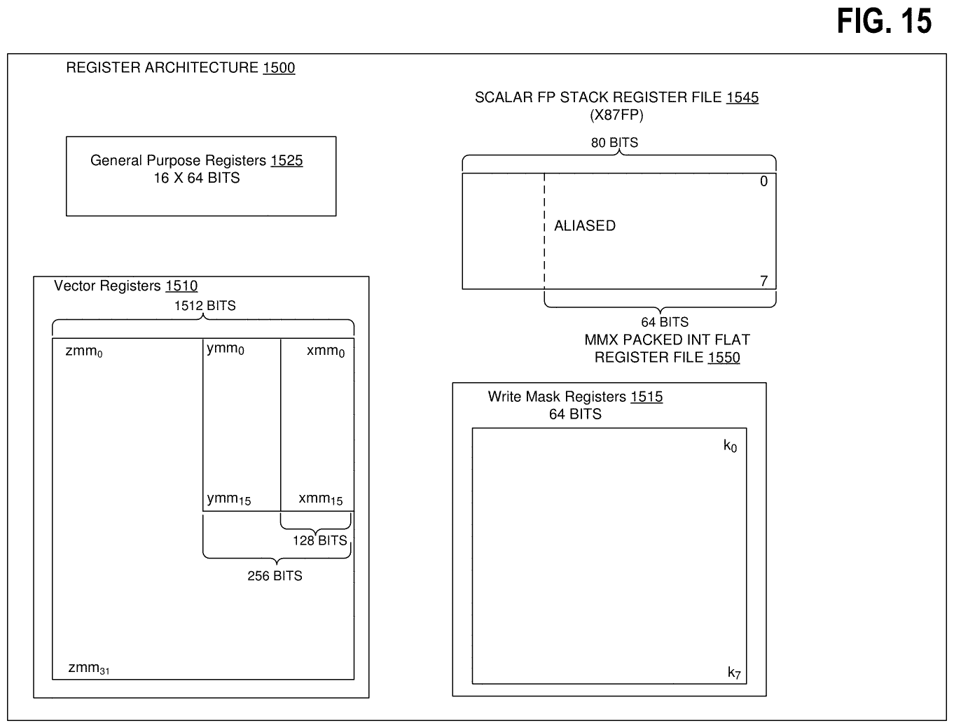

FIG. 15 is a block diagram of a register architecture 1500 according to one embodiment. In the embodiment illustrated, there are 32 vector registers 1510 that are 1512 bits wide; these registers are referenced as ZMM0 through ZMM31. The lower order 256 bits of the lower 16 ZMM registers are overlaid on registers YMM0-16. The lower order 128 bits of the lower 16 ZMM registers (the lower order 128 bits of the YMM registers) are overlaid on registers XMM0-15. In other words, the vector length field 459B selects between a maximum length and one or more other shorter lengths, where each such shorter length is half the length of the preceding length; and instructions templates without the vector length field 459B operate on the maximum vector length. Further, in one embodiment, the class B instruction templates of the instruction format 400 operate on packed or scalar single/double-precision floating point data and packed or scalar integer data. Scalar operations are operations performed on the lowest order data element position in a ZMM/YMM/XMM register; the higher order data element positions are either left the same as they were prior to the instruction or zeroed depending on the embodiment.

Writemask registers 1515—in the embodiment illustrated, there are 8 writemask registers (k0 through k7), each 64 bits in size. In an alternate embodiment, the writemask registers 1515 are 16 bits in size. In some embodiments, the vector mask register k0 cannot be used as a writemask; when the encoding that would normally indicate k0 is used for a writemask, it selects a hardwired writemask of 0xFFFF, effectively disabling writemasking for that instruction.

General-purpose registers 1525—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 1545, on which is aliased the MMX packed integer flat register file 1550—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments may use wider or narrower registers. Additionally, alternative embodiments may use more, less, or different register files and registers.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU (Central Processing Unit) including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

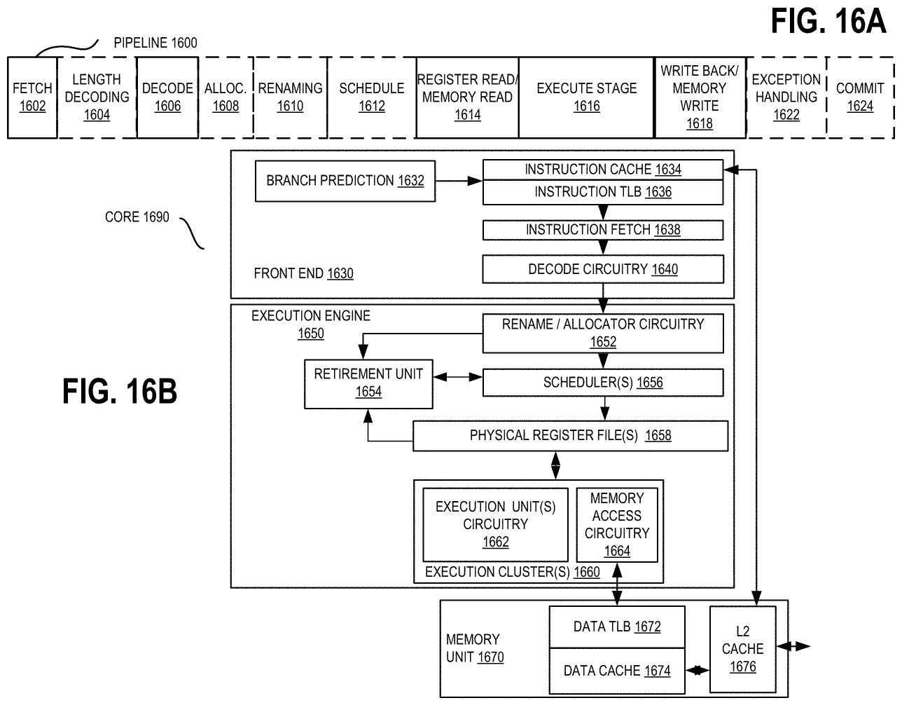

FIG. 16A is a block diagram illustrating both an exemplary in-order pipeline and an exemplary register renaming, out-of-order issue/execution pipeline according to embodiments. FIG. 16B is a block diagram illustrating both an exemplary embodiment of an in-order architecture core and an exemplary register renaming, out-of-order issue/execution architecture core to be included in a processor according to embodiments. The solid lined boxes in FIGS. 16A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 16A, a processor pipeline 1600 includes a fetch stage 1602, a length decode stage 1604, a decode stage 1606, an allocation stage 1608, a renaming stage 1610, a scheduling (also known as a dispatch or issue) stage 1612, a register read/memory read stage 1614, an execute stage 1616, a write back/memory write stage 1618, an exception handling stage 1622, and a commit stage 1624.

FIG. 16B shows processor core 1690 including a front end unit 1630 coupled to an execution engine unit 1650, and both are coupled to a memory unit 1670. The core 1690 may be a reduced instruction set computing (RISC) core, a complex instruction set computing (CISC) core, a very long instruction word (VLIW) core, or a hybrid or alternative core type. As yet another option, the core 1690 may be a special-purpose core, such as, for example, a network or communication core, compression engine, coprocessor core, general purpose computing graphics processing unit (GPGPU) core, graphics core, or the like.

The front end unit 1630 includes a branch prediction unit 1632 coupled to an instruction cache unit 1634, which is coupled to an instruction translation lookaside buffer (TLB) 1636, which is coupled to an instruction fetch unit 1638, which is coupled to a decode unit 1640. The decode unit 1640 (or decoder) may decode instructions, and generate as an output one or more micro-operations, micro-code entry points, microinstructions, other instructions, or other control signals, which are decoded from, or which otherwise reflect, or are derived from, the original instructions. The decode unit 1640 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1690 includes a microcode ROM or other medium that stores microcode for certain macroinstructions (e.g., in decode unit 1640 or otherwise within the front end unit 1630). The decode unit 1640 is coupled to a rename/allocator unit 1652 in the execution engine unit 1650.

The execution engine unit 1650 includes the rename/allocator unit 1652 coupled to a retirement unit 1654 and a set of one or more scheduler unit(s) 1656. The scheduler unit(s) 1656 represents any number of different schedulers, including reservations stations, central instruction window, etc. The scheduler unit(s) 1656 is coupled to the physical register file(s) unit(s) 1658. Each of the physical register file(s) units 1658 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1658 comprises a vector registers unit, a writemask registers unit, and a scalar registers unit. These register units may provide architectural vector registers, vector mask registers, and general purpose registers. The physical register file(s) unit(s) 1658 is overlapped by the retirement unit 1654 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1654 and the physical register file(s) unit(s) 1658 are coupled to the execution cluster(s) 1660. The execution cluster(s) 1660 includes a set of one or more execution units 1662 and a set of one or more memory access units 1664. The execution units 1662 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1656, physical register file(s) unit(s) 1658, and execution cluster(s) 1660 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1664). It should also be understood that where separate pipelines are used, one or more of these pipelines may be out-of-order issue/execution and the rest in-order.

The set of memory access units 1664 is coupled to the memory unit 1670, which includes a data TLB unit 1672 coupled to a data cache unit 1674 coupled to a level 2 (L2) cache unit 1676. In one exemplary embodiment, the memory access units 1664 may include a load unit, a store address unit, and a store data unit, each of which is coupled to the data TLB unit 1672 in the memory unit 1670. The instruction cache unit 1634 is further coupled to a level 2 (L2) cache unit 1676 in the memory unit 1670. The L2 cache unit 1676 is coupled to one or more other levels of cache and eventually to a main memory.

By way of example, the exemplary register renaming, out-of-order issue/execution core architecture may implement the pipeline 1600 as follows: 1) the instruction fetch 1638 performs the fetch and length decoding stages 1602 and 1604; 2) the decode unit 1640 performs the decode stage 1606; 3) the rename/allocator unit 1652 performs the allocation stage 1608 and renaming stage 1610; 4) the scheduler unit(s) 1656 performs the schedule stage 1612; 5) the physical register file(s) unit(s) 1658 and the memory unit 1670 perform the register read/memory read stage 1614; the execution cluster 1660 perform the execute stage 1616; 6) the memory unit 1670 and the physical register file(s) unit(s) 1658 perform the write back/memory write stage 1618; 7) various units may be involved in the exception handling stage 1622; and 8) the retirement unit 1654 and the physical register file(s) unit(s) 1658 perform the commit stage 1624.

The core 1690 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1690 includes logic to support a packed data instruction set extension (e.g., AVX1, AVX2), thereby allowing the operations used by many multimedia applications to be performed using packed data.

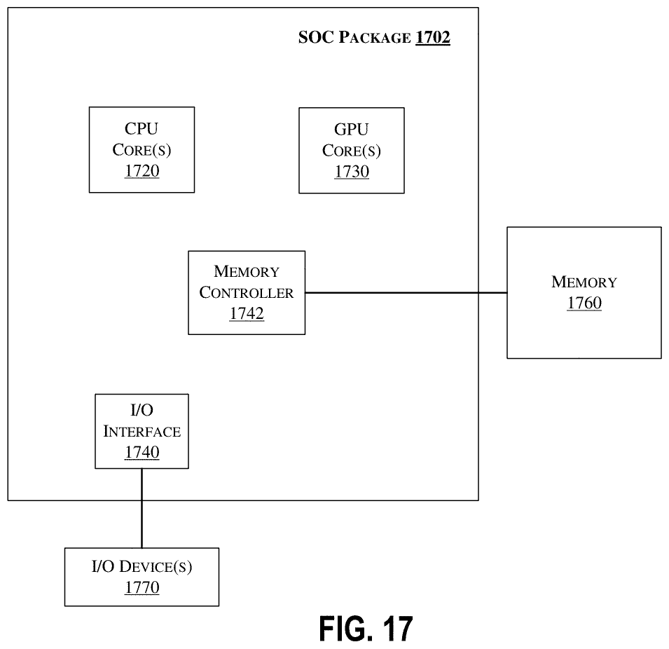

FIG. 17 illustrates a block diagram of an SOC package in accordance with an embodiment. As illustrated in FIG. 17, SOC 1702 includes one or more Central Processing Unit (CPU) cores 1720, one or more Graphics Processor Unit (GPU) cores 1730, an Input/Output (I/O) interface 1740, and a memory controller 1742. Various components of the SOC package 1702 may be coupled to an interconnect or bus such as discussed herein with reference to the other figures. Also, the SOC package 1702 may include more or less components, such as those discussed herein with reference to the other figures. Further, each component of the SOC package 1702 may include one or more other components, e.g., as discussed with reference to the other figures herein. In one embodiment, SOC package 1702 (and its components) is provided on one or more Integrated Circuit (IC) die, e.g., which are packaged into a single semiconductor device.

As illustrated in FIG. 17, SOC package 1702 is coupled to a memory 1760 via the memory controller 1742. In an embodiment, the memory 1760 (or a portion of it) can be integrated on the SOC package 1702.

The I/O interface 1740 may be coupled to one or more I/O devices 1770, e.g., via an interconnect and/or bus such as discussed herein with reference to other figures. I/O device(s) 1770 may include one or more of a keyboard, a mouse, a touchpad, a display, an image/video capture device (such as a camera or camcorder/video recorder), a touch screen, a speaker, or the like.

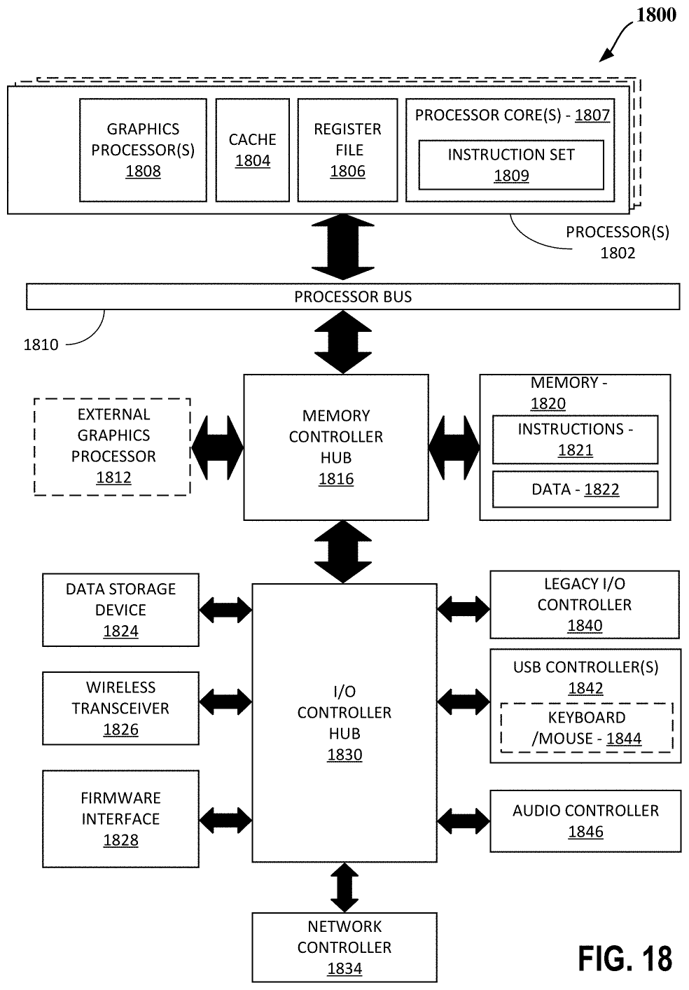

FIG. 18 is a block diagram of a processing system 1800, according to an embodiment. In various embodiments the system 1800 includes one or more processors 1802 and one or more graphics processors 1808, and may be a single processor desktop system, a multiprocessor workstation system, or a server system having a large number of processors 1802 or processor cores 1807. In on embodiment, the system 1800 is a processing platform incorporated within a system-on-a-chip (SoC or SOC) integrated circuit for use in mobile, handheld, or embedded devices.

An embodiment of system 1800 can include, or be incorporated within a server-based gaming platform, a game console, including a game and media console, a mobile gaming console, a handheld game console, or an online game console. In some embodiments system 1800 is a mobile phone, smart phone, tablet computing device or mobile Internet device. Data processing system 1800 can also include, couple with, or be integrated within a wearable device, such as a smart watch wearable device, smart eyewear device, augmented reality device, or virtual reality device. In some embodiments, data processing system 1800 is a television or set top box device having one or more processors 1802 and a graphical interface generated by one or more graphics processors 1808.

In some embodiments, the one or more processors 1802 each include one or more processor cores 1807 to process instructions which, when executed, perform operations for system and user software. In some embodiments, each of the one or more processor cores 1807 is configured to process a specific instruction set 1809. In some embodiments, instruction set 1809 may facilitate Complex Instruction Set Computing (CISC), Reduced Instruction Set Computing (RISC), or computing via a Very Long Instruction Word (VLIW). Multiple processor cores 1807 may each process a different instruction set 1809, which may include instructions to facilitate the emulation of other instruction sets. Processor core 1807 may also include other processing devices, such a Digital Signal Processor (DSP).

In some embodiments, the processor 1802 includes cache memory 1804. Depending on the architecture, the processor 1802 can have a single internal cache or multiple levels of internal cache. In some embodiments, the cache memory is shared among various components of the processor 1802. In some embodiments, the processor 1802 also uses an external cache (e.g., a Level-3 (L3) cache or Last Level Cache (LLC)) (not shown), which may be shared among processor cores 1807 using known cache coherency techniques. A register file 1806 is additionally included in processor 1802 which may include different types of registers for storing different types of data (e.g., integer registers, floating point registers, status registers, and an instruction pointer register). Some registers may be general-purpose registers, while other registers may be specific to the design of the processor 1802.

In some embodiments, processor 1802 is coupled to a processor bus 1810 to transmit communication signals such as address, data, or control signals between processor 1802 and other components in system 1800. In one embodiment the system 1800 uses an exemplary ‘hub’ system architecture, including a memory controller hub 1816 and an Input Output (I/O) controller hub 1830. A memory controller hub 1816 facilitates communication between a memory device and other components of system 1800, while an I/O Controller Hub (ICH) 1830 provides connections to I/O devices via a local I/O bus. In one embodiment, the logic of the memory controller hub 1816 is integrated within the processor.

Memory device 1820 can be a dynamic random access memory (DRAM) device, a static random access memory (SRAM) device, flash memory device, phase-change memory device, or some other memory device having suitable performance to serve as process memory. In one embodiment the memory device 1820 can operate as system memory for the system 1800, to store data 1822 and instructions 1821 for use when the one or more processors 1802 executes an application or process. Memory controller hub 1816 also couples with an optional external graphics processor 1812, which may communicate with the one or more graphics processors 1808 in processors 1802 to perform graphics and media operations.

In some embodiments, ICH 1830 enables peripherals to connect to memory device 1820 and processor 1802 via a high-speed I/O bus. The I/O peripherals include, but are not limited to, an audio controller 1846, a firmware interface 1828, a wireless transceiver 1826 (e.g., Wi-Fi, Bluetooth), a data storage device 1824 (e.g., hard disk drive, flash memory, etc.), and a legacy I/O controller 1840 for coupling legacy (e.g., Personal System 2 (PS/2)) devices to the system. One or more Universal Serial Bus (USB) controllers 1842 connect input devices, such as keyboard and mouse 1844 combinations. A network controller 1834 may also couple to ICH 1830. In some embodiments, a high-performance network controller (not shown) couples to processor bus 1810. It will be appreciated that the system 1800 shown is exemplary and not limiting, as other types of data processing systems that are differently configured may also be used. For example, the I/O controller hub 1830 may be integrated within the one or more processor 1802, or the memory controller hub 1816 and I/O controller hub 1830 may be integrated into a discreet external graphics processor, such as the external graphics processor 1812.

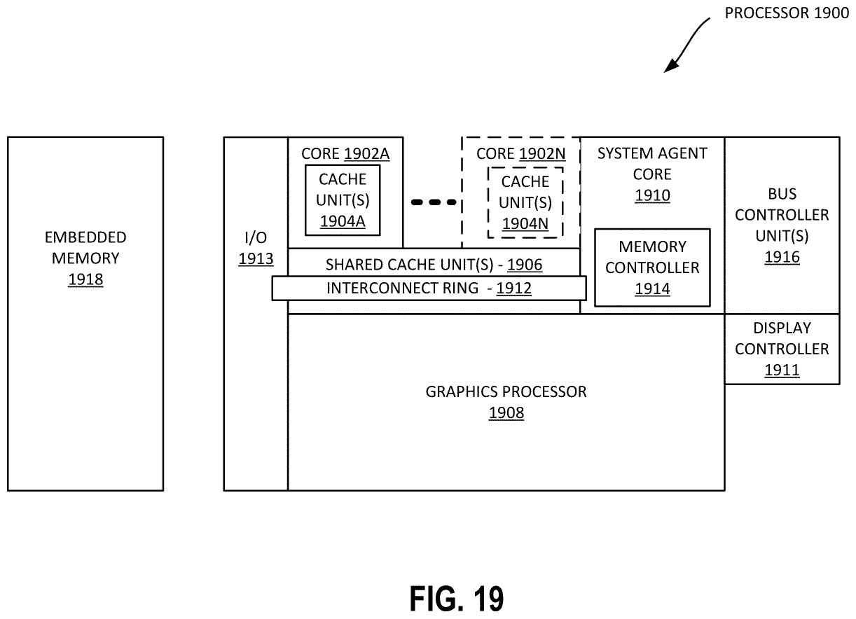

FIG. 19 is a block diagram of an embodiment of a processor 1900 having one or more processor cores 1902A to 1902N, an integrated memory controller 1914, and an integrated graphics processor 1908. Those elements of FIG. 19 having the same reference numbers (or names) as the elements of any other figure herein can operate or function in any manner similar to that described elsewhere herein, but are not limited to such. Processor 1900 can include additional cores up to and including additional core 1902N represented by the dashed lined boxes. Each of processor cores 1902A to 1902N includes one or more internal cache units 1904A to 1904N. In some embodiments each processor core also has access to one or more shared cached units 1906.

The internal cache units 1904A to 1904N and shared cache units 1906 represent a cache memory hierarchy within the processor 1900. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 1906 and 1904A to 1904N.

In some embodiments, processor 1900 may also include a set of one or more bus controller units 1916 and a system agent core 1910. The one or more bus controller units 1916 manage a set of peripheral buses, such as one or more Peripheral Component Interconnect buses (e.g., PCI, PCI Express). System agent core 1910 provides management functionality for the various processor components. In some embodiments, system agent core 1910 includes one or more integrated memory controllers 1914 to manage access to various external memory devices (not shown).

In some embodiments, one or more of the processor cores 1902A to 1902N include support for simultaneous multi-threading. In such embodiment, the system agent core 1910 includes components for coordinating and operating cores 1902A to 1902N during multi-threaded processing. System agent core 1910 may additionally include a power control unit (PCU), which includes logic and components to regulate the power state of processor cores 1902A to 1902N and graphics processor 1908.

In some embodiments, processor 1900 additionally includes graphics processor 1908 to execute graphics processing operations. In some embodiments, the graphics processor 1908 couples with the set of shared cache units 1906, and the system agent core 1910, including the one or more integrated memory controllers 1914. In some embodiments, a display controller 1911 is coupled with the graphics processor 1908 to drive graphics processor output to one or more coupled displays. In some embodiments, display controller 1911 may be a separate module coupled with the graphics processor via at least one interconnect, or may be integrated within the graphics processor 1908 or system agent core 1910.

In some embodiments, a ring based interconnect unit 1912 is used to couple the internal components of the processor 1900. However, an alternative interconnect unit may be used, such as a point-to-point interconnect, a switched interconnect, or other techniques, including techniques well known in the art. In some embodiments, graphics processor 1908 couples with the ring interconnect 1912 via an I/O link 1913.

The exemplary I/O link 1913 represents at least one of multiple varieties of I/O interconnects, including an on package I/O interconnect which facilitates communication between various processor components and a high-performance embedded memory module 1918, such as an eDRAM (or embedded DRAM) module. In some embodiments, each of the processor cores 1902 to 1902N and graphics processor 1908 use embedded memory modules 1918 as a shared Last Level Cache.

In some embodiments, processor cores 1902A to 1902N are homogenous cores executing the same instruction set architecture. In another embodiment, processor cores 1902A to 1902N are heterogeneous in terms of instruction set architecture (ISA), where one or more of processor cores 1902A to 1902N execute a first instruction set, while at least one of the other cores executes a subset of the first instruction set or a different instruction set. In one embodiment processor cores 1902A to 1902N are heterogeneous in terms of microarchitecture, where one or more cores having a relatively higher power consumption couple with one or more power cores having a lower power consumption. Additionally, processor 1900 can be implemented on one or more chips or as an SoC integrated circuit having the illustrated components, in addition to other components.

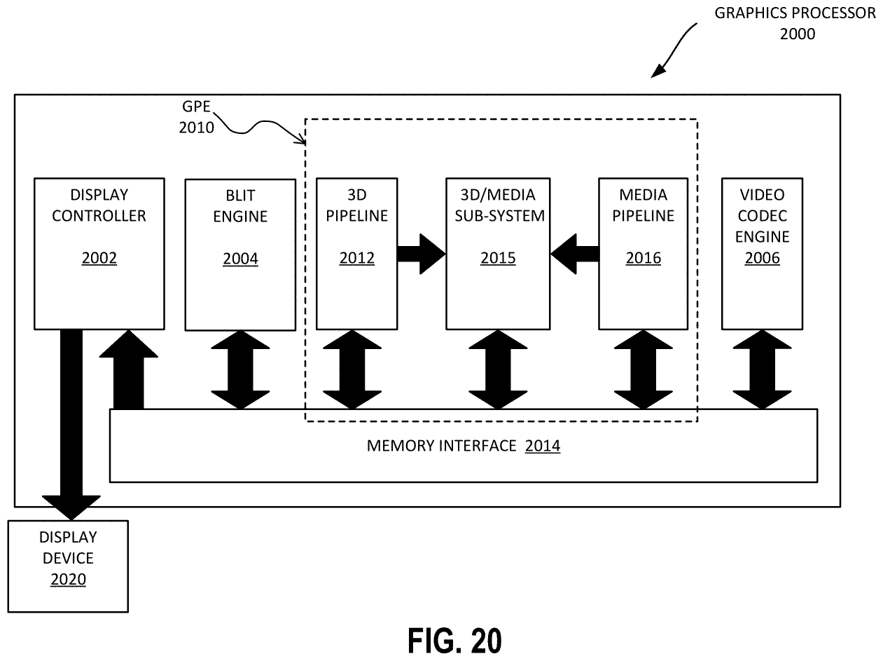

FIG. 20 is a block diagram of a graphics processor 2000, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 2000 includes a memory interface 2014 to access memory. Memory interface 2014 can be an interface to local memory, one or more internal caches, one or more shared external caches, and/or to system memory.

In some embodiments, graphics processor 2000 also includes a display controller 2002 to drive display output data to a display device 2020. Display controller 2002 includes hardware for one or more overlay planes for the display and composition of multiple layers of video or user interface elements. In some embodiments, graphics processor 2000 includes a video codec engine 2006 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 321M/VC-1, and Joint Photographic Experts Group (JPEG) formats such as JPEG, and Motion JPEG (MJPEG) formats.

In some embodiments, graphics processor 2000 includes a block image transfer (BLIT) engine 2004 to perform two-dimensional (2D) rasterizer operations including, for example, bit-boundary block transfers. However, in one embodiment, 3D graphics operations are performed using one or more components of graphics processing engine (GPE) 2010. In some embodiments, graphics processing engine 2010 is a compute engine for performing graphics operations, including three-dimensional (3D) graphics operations and media operations.

In some embodiments, GPE 2010 includes a 3D pipeline 2012 for performing 3D operations, such as rendering three-dimensional images and scenes using processing functions that act upon 3D primitive shapes (e.g., rectangle, triangle, etc.). The 3D pipeline 2012 includes programmable and fixed function elements that perform various tasks within the element and/or spawn execution threads to a 3D/Media sub-system 2015. While 3D pipeline 2012 can be used to perform media operations, an embodiment of GPE 2010 also includes a media pipeline 2016 that is specifically used to perform media operations, such as video post-processing and image enhancement.

In some embodiments, media pipeline 2016 includes fixed function or programmable logic units to perform one or more specialized media operations, such as video decode acceleration, video de-interlacing, and video encode acceleration in place of, or on behalf of video codec engine 2006. In some embodiments, media pipeline 2016 additionally includes a thread spawning unit to spawn threads for execution on 3D/Media sub-system 2015. The spawned threads perform computations for the media operations on one or more graphics execution units included in 3D/Media sub-system 2015.

In some embodiments, 3D/Media subsystem 2015 includes logic for executing threads spawned by 3D pipeline 2012 and media pipeline 2016. In one embodiment, the pipelines send thread execution requests to 3D/Media subsystem 2015, which includes thread dispatch logic for arbitrating and dispatching the various requests to available thread execution resources. The execution resources include an array of graphics execution units to process the 3D and media threads. In some embodiments, 3D/Media subsystem 2015 includes one or more internal caches for thread instructions and data. In some embodiments, the subsystem also includes shared memory, including registers and addressable memory, to share data between threads and to store output data.

In the following description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes an apparatus comprising: Physically Unclonable Function (PUF) circuitry; decode circuitry to decode an instruction having a field for an address of a memory buffer; and execution circuitry to execute the decoded instruction to: determine data to be cryptographically protected and determine a challenge; and cryptographically protect the data in accordance with a key, wherein the PUF circuitry is to generate the key in response to the challenge. Example 2 includes the apparatus of example 1, wherein the execution circuitry is to cryptographically protect the data in accordance with the key and a Security Version Number (SVN). Example 3 includes the apparatus of example 1, wherein the execution circuitry is to cause the cryptographically protected data to be stored in memory. Example 4 includes the apparatus of example 1, wherein the execution circuitry is to cryptographically protect the data in accordance with the key and a Security Version Number (SVN), wherein the execution circuitry is to cause the cryptographically protected data and the SVN to be stored in memory. Example 5 includes the apparatus of example 1, wherein the PUF circuitry is to generate a plurality of keys in response to the challenge, wherein each of the plurality of keys is to be utilized for different uses. Example 6 includes the apparatus of example 5, wherein the different uses comprise fuse protection or a software visible PUF use. Example 7 includes the apparatus of example 1, wherein the decode circuitry is to decode a second instruction to determine presence of the cryptographically protected data and a second challenge, wherein the execution circuitry is to execute the second decoded instruction to cryptographically unprotect the protected data in accordance with a second key, wherein the PUF circuitry is to generate the second key in response to the second challenge. Example 8 includes the apparatus of example 7, wherein the execution circuitry is to execute the second decoded instruction is to cryptographically unprotect the protected data in accordance with the second key and an SVN. Example 9 includes the apparatus of example 8, comprising verification logic to determine an integrity of the unprotected data based on the SVN and a current SVN. Example 10 includes the apparatus of example 9, wherein, in response to a successful integrity verification by the verification logic, the unprotected data is returned. Example 11 includes the apparatus of example 9, wherein, in response to an unsuccessful integrity verification by the verification logic, a signal is to be generated in accordance with a policy to be selected at a time the execution circuitry is to execute the decoded instruction. Example 12 includes the apparatus of example 1, wherein the data comprises a key corresponding to a hardware block. Example 13 includes the apparatus of example 1, wherein the challenge is a 256 bit random value. Example 14 includes the apparatus of example 1, wherein the decode circuitry is to decode a second instruction to determine presence of the cryptographically protected data and a second challenge, wherein the execution circuitry is to execute the second decoded instruction to cryptographically unprotect the protected data in accordance with a second key and in response to a determination that a configuration is active, wherein the PUF circuitry is to generate the second key in response to the second challenge. Example 15 includes the apparatus of example 14, wherein the configuration is to be selected at a time the execution circuitry is to execute the decoded instruction.

Example 16 includes an apparatus comprising: Physically Unclonable Function (PUF) circuitry; decode circuitry to decode an instruction having a field for an address of a memory buffer; and execution circuitry to execute the decoded instruction to: determine data to be cryptographically unprotected and determine a challenge; and cryptographically unprotect the data in accordance with a key, wherein the PUF circuitry is to generate the key in response to the challenge. Example 17 includes the apparatus of example 16, wherein the execution circuitry is to cryptographically unprotect the protected data in accordance with the key and a SVN. Example 18 includes the apparatus of example 17, comprising verification logic to determine an integrity of the unprotected data based on the SVN and a current SVN. Example 19 includes the apparatus of example 18, wherein, in response to a successful integrity verification by the verification logic, the unprotected data is returned. Example 20 includes the apparatus of example 18, wherein, in response to an unsuccessful integrity verification by the verification logic, a signal is to be generated in accordance with a policy to be selected at a time the execution circuitry is to execute a second decoded instruction to cryptographically protect the data. Example 21 includes the apparatus of example 16, wherein the data comprises a key corresponding to a hardware block. Example 22 includes the apparatus of example 16, wherein the challenge is a 256 bit random value.

Example 23 includes one or more non-transitory computer-readable media comprising one or more instructions that when executed on a processor configure the processor to perform one or more operations to: decode an instruction having a field for an address of a memory buffer; and execute the decoded instruction to: determine data to be cryptographically protected and determine a challenge; and cryptographically protect the data in accordance with a key, wherein a Physically Unclonable Function (PUF) circuitry is to generate the key in response to the challenge. Example 24 includes the one or more computer-readable media of example 23, further comprising one or more instructions that when executed on the at least one processor configure the at least one processor to perform one or more operations to cause cryptographical protection of the data in accordance with the key and a Security Version Number (SVN). Example 25 includes the one or more computer-readable media of example 23, further comprising one or more instructions that when executed on the at least one processor configure the at least one processor to perform one or more operations to cause storage of the cryptographically protected data in memory.

Example 26 includes an apparatus comprising means to perform a method as set forth in any preceding example. Example 27 includes machine-readable storage including machine-readable instructions, when executed, to implement a method or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

In various embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
Physically Unclonable Function (PUF) circuitry;
decode circuitry to decode an instruction having a field for an address of a memory buffer; and
execution circuitry to execute the decoded instruction to:
determine data to be cryptographically protected and determine a challenge; and
cryptographically protect the data in accordance with a key, wherein the PUF circuitry is to generate the key in response to the challenge.

2. The apparatus of claim 1, wherein the execution circuitry is to cryptographically protect the data in accordance with the key and a Security Version Number (SVN).

3. The apparatus of claim 1, wherein the execution circuitry is to cause the cryptographically protected data to be stored in memory.

4. The apparatus of claim 1, wherein the execution circuitry is to cryptographically protect the data in accordance with the key and a Security Version Number (SVN), wherein the execution circuitry is to cause the cryptographically protected data and the SVN to be stored in memory.

5. The apparatus of claim 1, wherein the PUF circuitry is to generate a plurality of keys in response to the challenge, wherein each of the plurality of keys is to be utilized for different uses.

6. The apparatus of claim 5, wherein the different uses comprise fuse protection or a software-visible PUF use.

7. The apparatus of claim 1, wherein the decode circuitry is to decode a second instruction to determine presence of the cryptographically protected data and a second challenge, wherein the execution circuitry is to execute the second decoded instruction to cryptographically unprotect the protected data in accordance with a second key, wherein the PUF circuitry is to generate the second key in response to the second challenge.

8. The apparatus of claim 7, wherein the execution circuitry is to execute the second decoded instruction is to cryptographically unprotect the protected data in accordance with the second key and an SVN.

9. The apparatus of claim 8, comprising verification logic to determine an integrity of the unprotected data based on the SVN and a current SVN.

10. The apparatus of claim 9, wherein, in response to a successful integrity verification by the verification logic, the unprotected data is returned.

11. The apparatus of claim 9, wherein, in response to an unsuccessful integrity verification by the verification logic, a signal is to be generated in accordance with a policy to be selected at a time the execution circuitry is to execute the decoded instruction.

12. The apparatus of claim 1, wherein the data comprises a key corresponding to a hardware block.

13. The apparatus of claim 1, wherein the challenge is a 256 bit random value.

14. The apparatus of claim 1, wherein the decode circuitry is to decode a second instruction to determine presence of the cryptographically protected data and a second challenge, wherein the execution circuitry is to execute the second decoded instruction to cryptographically unprotect the protected data in accordance with a second key and in response to a determination that a configuration is active, wherein the PUF circuitry is to generate the second key in response to the second challenge.

15. The apparatus of claim 14, wherein the configuration is to be selected at a time the execution circuitry is to execute the decoded instruction.

16. An apparatus comprising:
Physically Unclonable Function (PUF) circuitry;
decode circuitry to decode an instruction having a field for an address of a memory buffer; and
execution circuitry to execute the decoded instruction to:
determine data to be cryptographically unprotected and determine a challenge; and
cryptographically unprotect the data in accordance with a key, wherein the PUF circuitry is to generate the key in response to the challenge.

17. The apparatus of claim 16, wherein the execution circuitry is to cryptographically unprotect the protected data in accordance with the key and a SVN.

18. The apparatus of claim 17, comprising verification logic to determine an integrity of the unprotected data based on the SVN and a current SVN.

19. The apparatus of claim 18, wherein, in response to a successful integrity verification by the verification logic, the unprotected data is returned.

20. The apparatus of claim 18, wherein, in response to an unsuccessful integrity verification by the verification logic, a signal is to be generated in accordance with a policy to be selected at a time the execution circuitry is to execute a second decoded instruction to cryptographically protect the data.

21. The apparatus of claim 16, wherein the data comprises a key corresponding to a hardware block.

22. The apparatus of claim 16, wherein the challenge is a 256 bit random value.

23. One or more non-transitory computer-readable media comprising one or more instructions that when executed on a processor configure the processor to perform one or more operations to:
decode an instruction having a field for an address of a memory buffer; and
execute the decoded instruction to:
determine data to be cryptographically protected and determine a challenge; and
cryptographically protect the data in accordance with a key, wherein a Physically Unclonable Function (PUF) circuitry is to generate the key in response to the challenge.

24. The one or more computer-readable media of claim 23, further comprising one or more instructions that when executed on the at least one processor configure the at least one processor to perform one or more operations to cause cryptographical protection of the data in accordance with the key and a Security Version Number (SVN).

25. The one or more computer-readable media of claim 23, further comprising one or more instructions that when executed on the at least one processor configure the at least one processor to perform one or more operations to cause storage of the cryptographically protected data in memory.
